(19) United States
(12) Patent Application Publication
(10) Pub. No.: US 2026/0140057 A1
(43) Pub. Date: May 21, 2026

(54) SPATIALLY MODULATED ILLUMINATION DEVICE

(71) Applicant: COMMISSARIAT A L'ÉNERGIE ATOMIQUE ET AUX ENERGIES ALTERNATIVES, Paris (FR)

(72) Inventors: Xavier MERMET, Grenoble Cedex 09 (FR); Jérôme VAILLANT, Grenoble Cedex 09 (FR); Benoit RACINE, Grenoble Cedex 09 (FR)

(73) Assignee: COMMISSARIAT A L'ÉNERGIE ATOMIQUE ET AUX ENERGIES ALTERNATIVES, Paris (FR)

(21) Appl. No.: 19/393,017

(22) Filed: Nov. 18, 2025

(30) Foreign Application Priority Data
Nov. 19, 2024 (FR) FR2412661

(51) Int. Cl. G01N 21/64; G02F 1/01

(52) U.S. Cl. CPC G01N 21/6486; G02F 1/0136; G01N 2201/067

(57) ABSTRACT

Device (1) for illuminating an object (3), the device being configured to be lit by a light source (2), and comprising:
a photodetector (10), comprising detection pixels (10ᵢ);
a modulator (20), formed from a matrix of modulation pixels (20ᵢ), interposed between the light source and the pixellated photodetector, each modulation pixel comprising a material an optical property of which varies depending on an electrical command;
a control unit (30), configured to activate each modulation pixel depending on a light intensity detected by the detection pixels;
the device being characterized in that:
   the surface of the photodetector transmits part of the light, so that the light transmitted by the pixellated photodetector illuminates the object;
   so that the device is configured to be placed between the light source and the object.

### TECHNICAL FIELD

The technical field of the invention is the observation of an object via a light source, the objective being to illuminate the object according to a predetermined illumination pattern. The object may be a sample or a scene.

### PRIOR ART

Some methods for observing a sample implement a light source, configured to illuminate a sample. These are, for example, methods for fluorescence imaging, or for absorbance imaging, of a sample. In this type of method, it is preferable to illuminate the sample as homogeneously as possible. An example of a method implementing fluorescence is quantitative PCR (polymerase chain reaction).

In order to obtain homogeneous illumination, a diffuser may be arranged between the light source and the sample. However, homogenization is difficult to control. In addition, the use of a diffuser only makes homogenization possible, without the possibility of defining another spatial distribution of the illumination.

EP1751972 describes a modulator which makes it possible to spatially modulate the intensity of the light reaching an image sensor, so as to obtain uniform illumination of the image sensor. The modulator is adjusted depending on the image formed by the image sensor. The implementation of such a modulator assumes the use of a light separation means, so as to direct part of the light towards the image sensor, and another part towards the observed sample. This assumes adjustment. This also compromises the compactness of the whole.

The invention aims to define a compact modulation device, which makes it possible to spatially modulate a light beam propagating along a propagation axis, the spatial modulation being carried out in a plane which is perpendicular, or substantially perpendicular, to the propagation axis, according to a predetermined pattern.

### SUMMARY OF THE INVENTION

A first object of the invention is a device for illuminating an object, the device being configured to be lit by a light source, the light source emitting light in an emission spectral band, the device comprising:
a pixellated photodetector, comprising detection pixels distributed along a detection surface;
a modulator, formed from a matrix of modulation pixels, interposed between the light source and the pixellated photodetector, each modulation pixel comprising a material an optical property of which varies depending on an electrical command applied to said modulation pixel;
a control unit, configured to activate each modulation pixel depending on a light intensity detected by the detection pixels, so as to modify a light transmission of at least one modulation pixel;
   wherein:
the detection surface transmits part of the light in the emission spectral band, so that the light transmitted by the pixellated photodetector illuminates the object;
so that the device is configured to be placed between the light source and the object.

Each detection pixel may transmit at least 50%, or at least 60%, or at least 70% of the light in the emission spectral band.

Two adjacent detection pixels may be spaced apart from one another, so as to form an empty space, on the detection surface, between said adjacent pixels, the empty space transmitting at least 50% or at least 60%, or at least 70% of the light in the emission spectral band.

Each modulation pixel may be configured to modify a polarization direction of light depending on the electrical command applied to said modulation pixel, the device comprising an output polarizer interposed between the modulator and the pixellated photodetector.

The device may comprise an input polarizer, the device being such that the modulator is interposed between the input polarizer and the output polarizer.

Each modulation pixel may be configured to modify an absorbance of the light emitted by the light source depending on the electrical command applied to said modulation pixel.

The control unit may be configured to:
a) store an illumination pattern;
b) receive a detection signal representing a light intensity detected by the pixels of the photodetector;
c) activate each modulation pixel depending on the light intensity detected by the pixels of the photodetector and the stored illumination pattern.

The pixellated photodetector and the modulator may be attached to one another.

The pixellated photodetector and the modulator may be arranged in contact with one another or at a distance of less than 1 cm from one another.

The invention will be better understood on reading the disclosure of the exemplary embodiments presented, in the remainder of the description, with reference to the figures listed below.

### FIGURES

FIG. 1 schematically depicts an implementation of the device according to the invention.

FIG. 2 depicts the pixels of a photodetector of the device according to a first embodiment.

FIG. 3A schematically depicts an illumination profile, along an axis, without implementation of the invention.

FIG. 3B schematically depicts an example of an illumination profile obtained by implementing the invention.

FIG. 3C shows another example of an illumination profile obtained by implementing the invention.

FIGS. 4A to 4L illustrate steps of manufacturing a device according to the first embodiment of the invention.

FIG. 5 shows an example of filling the liquid crystal matrix.

FIG. 6A shows electrodes which make it possible to address detection pixels.

FIG. 6B shows electrodes which make it possible to address modulation pixels.

FIG. 7 shows an embodiment of the invention.

FIG. 8 shows a variant embodiment of the invention.

FIG. 9 shows another variant embodiment of the invention.

FIG. 10 depicts the main steps implemented by the control unit.

FIGS. 11A to 11D depict various connection configurations of detection pixels.

### DISCLOSURE OF PARTICULAR EMBODIMENTS

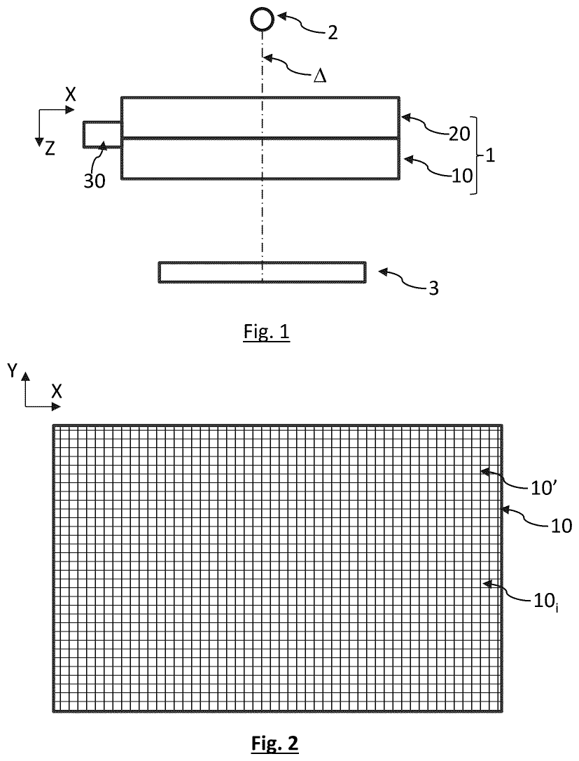

FIG. 1 shows a holistic view of a device 1 according to the invention. The device is intended to be interposed between a light source 2 and an object 3. The device comprises a pixellated photodetector 10 and a modulator 20. In this example, the modulator is formed by a liquid crystal matrix.

The object may be a sample, for example a biological sample, which there is a desire to analyse. It may also be a screen or another type of object.

The modulator 20 comprises modulation pixels 20ᵢ arranged in a matrix. The pixellated photodetector comprises detection pixels 10ᵢ, also arranged in a matrix manner. In the example described, there are as many detection pixels as there are modulation pixels. The index i is an integer designating a spatial coordinate of each detection pixel and of each modulation pixel. 1≤i≤I, I being the number of modulation and detection pixels. Each modulation pixel is arranged opposite a detection pixel.

Preferably, the pixellated photodetector 10 and the modulator 20 are integral with one another. They are preferably attached to each other, so as to minimize a distance between the detection pixels of the photodetector and the elementary liquid crystals. The distance between the photodetector 10 and the modulator 20 is preferably less than 1 cm. In this example, the photodetector 10 is in contact with the modulator 20, this corresponding to the preferred configuration.

Each modulation pixel 10ᵢ makes it possible to modulate an intensity of the light detected by a detection pixel 10ᵢ when the light source lights the device.

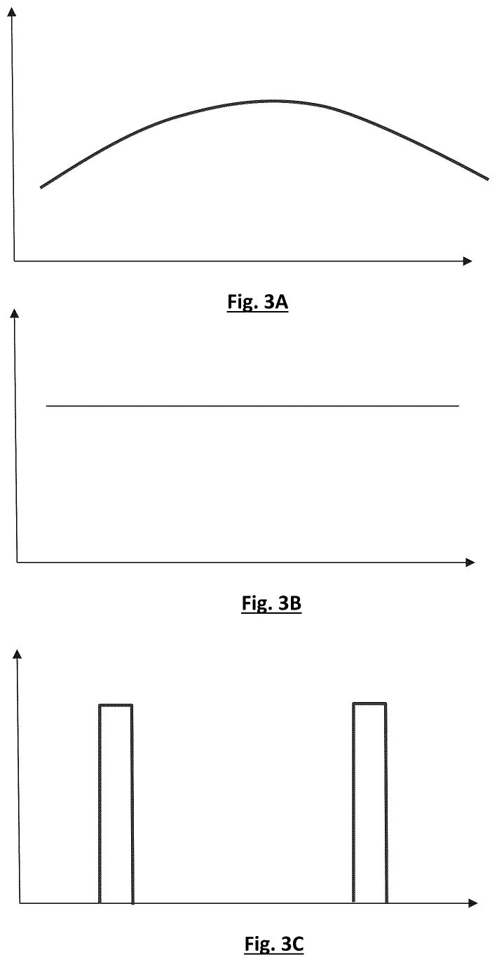

FIG. 2 schematically depicts the detection pixels 10ᵢ of the photodetector 10. The detection pixels are distributed along a detection surface 10′.

The light source 2 emits light which propagates about a propagation axis Δ which is parallel to a transverse axis Z. The modulator 20 and the pixellated photodetector 10 are preferably arranged perpendicularly, or substantially perpendicularly, to the transverse axis, parallel to a detection plane extending along a lateral axis X and a longitudinal axis Y, which is perpendicular to the lateral axis X. What is meant by “substantially perpendicularly” is perpendicular to within ±20° or ±30°.

The light source may emit in an emission spectral band, in the visible, or in the infrared, for example the short infrared, extending between 1 and 3 μm, or in the middle infrared, extending between 3 and 5 μm, or else in the long infrared, extending between 8 and 20 μm. In the detailed example described below, the light source emits in the visible spectrum. Implementation of the invention in the infrared is possible, subject to adaptation of the materials used for the transmission of light in the infrared.

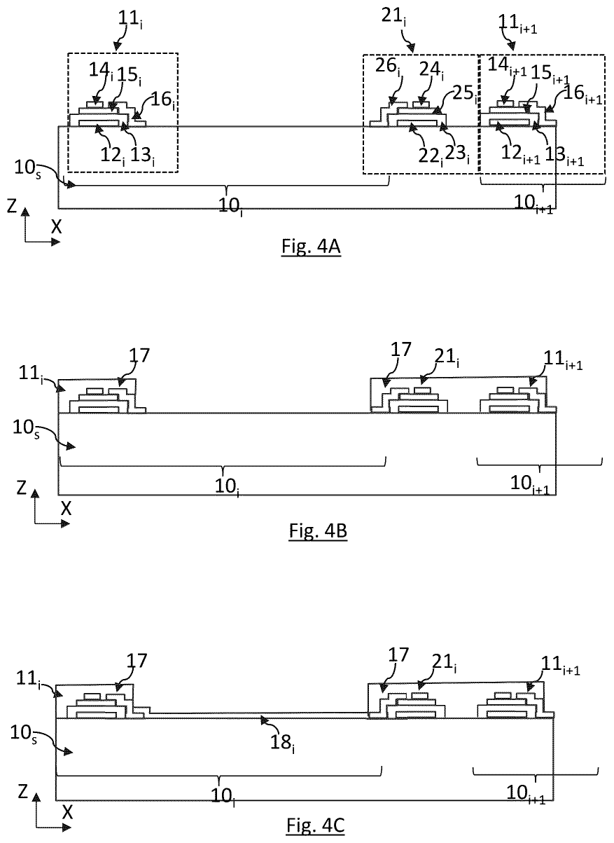

FIG. 3A illustrates a profile of a spatial distribution of the intensity of the light emitted by the light source 2, along an axis extending in the plane XY. It is observed that the luminous intensity is not homogeneous, and is maximum in a central part, opposite the light source. The objective of the invention is to structure the light beam emitted by the light source in such a way that it defines, in a plane which is perpendicular to the propagation axis, a predetermined pattern. This may be a homogeneous pattern, as depicted in FIG. 3B, or an inhomogeneous pattern, as depicted in FIG. 3C. In FIG. 3C, the beam is spatially modulated so as to form a ring. What is meant by “pattern” is a spatial distribution of light in a plane which is parallel to the detection plane.

The device comprises a control unit 30, connected to the photodetector 10 and to the modulator 20. The control unit comprises a microprocessor, or other computer, configured to analyse the intensity detected by each pixel 10ᵢ of the photodetector 10, and to address a control signal to each modulation pixel 20ᵢ so that the luminous intensity detected by each elementary pixel is spatially distributed according to a previously defined and stored illumination pattern.

The detection pixels of the pixellated photodetector are distributed along a detection surface 10′. An important aspect of the invention is that the detection surface transmits part of the light emitted by the light source, so that the light transmitted by the pixellated photodetector illuminates the object 3.

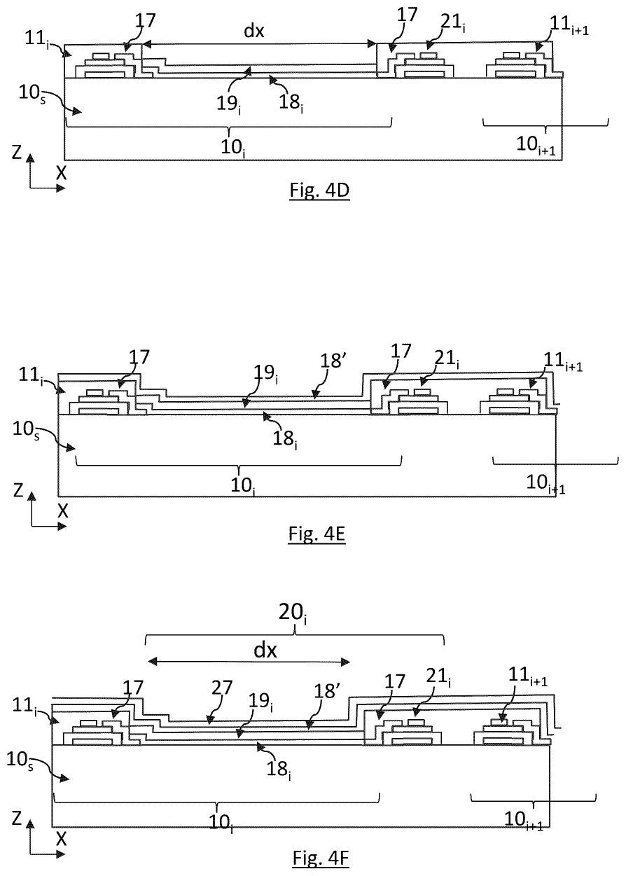

According to a first embodiment, described with reference to FIGS. 4A to 4L, each detection pixel transmits part of the light to which it is exposed, preferably at least 50%, or even at least 60%, or even at least 70% or 80% of the light to which it is exposed.

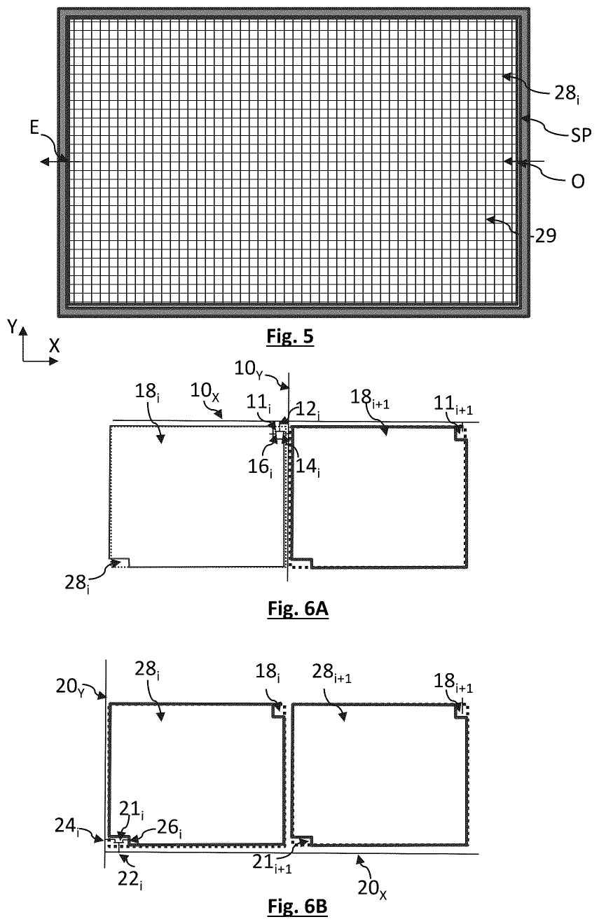

According to a second embodiment, described with reference to FIG. 7, the detection pixels are spaced apart from one another. Between the pixels, the detection surface 10′ transmits part of the light in the emission spectral band of the light source, preferably at least 50%, or even at least 60%, or even at least 70% or 80% of the light in the emission spectral band of the light source.

FIGS. 4A to 4L describe manufacturing an example of a device according to the first embodiment of the invention. FIGS. 4A to 4E show the formation of a detection pixel 10ᵢ, and FIGS. 4F to 4L show the formation of a modulation pixel 20ᵢ, coupled to the detection pixel 10ᵢ. In this example, the device comprises as many detection pixels 10ᵢ as there are modulation pixels 20ᵢ. The device comprises a photodetector support 10ₛ, on which the detection pixels 10ᵢ are formed. In the example depicted, each detection pixel 10ᵢ comprises a drive transistor 11ᵢ, intended to make it possible to collect charge carriers collected by a collecting electrode, generally an anode. In the example depicted, the drive transistor 11ᵢ is a TFT (thin-film transistor), which is a field-effect transistor usually used in flat screens, such as liquid-crystal displays or OLED (organic light-emitting diode) screens.

The photodetector support 10ₛ is transparent in the emission spectral band of the light source. In this example, the emission spectral band of the light source is in the visible range. The support 10ₛ is, for example, made of glass.

The drive transistor 11ᵢ of the detection pixel 10ᵢ is formed from a gate 12ᵢ, a source 14ᵢ and a drain 16ᵢ, which are made of a conductive material, for example a metal. The drive transistor 11ᵢ comprises a channel 15ᵢ formed from a thin film of semiconductor, for example Si, and separated from the gate by a thin film of insulator 13ᵢ, for example SiO₂.

Each detection pixel 10ᵢ is associated with a drive transistor 11ᵢ. In FIGS. 4A to 4L, only two drive transistors 11ᵢ and 11ᵢ₊₁ have been depicted. The drive transistor 11ᵢ₊₁, associated with the adjacent detection pixel 10ᵢ₊₁, comprises a gate 12ᵢ₊₁, a source 14ᵢ₊₁ and a drain 16ᵢ₊₁. The drive transistor 11ᵢ₊₁ comprises a channel 15ᵢ₊₁ separated from the gate by a thin film of insulator 13ᵢ₊₁.

A control transistor 21ᵢ of a modulation pixel 20ᵢ is formed on the support 10ₛ. It is also a TFT, of similar structure to the drive transistor 11ᵢ comprising a gate 22ᵢ, a source 24ᵢ and a drain 26ᵢ. The drive transistor 21ᵢ comprises a channel 25ᵢ separated from the gate by a thin film of insulator 23ᵢ. The materials forming each control transistor 21ᵢ may be identical to those composing each drive transistor 11ᵢ. Each modulation pixel 20ᵢ is associated with a drive transistor 21ᵢ.

The drive transistors of the detection pixels 10ᵢ and the control transistors of the modulation pixels 20ᵢ are covered with a layer of insulator 17, for example SiO₂: cf. FIG. 4B. The insulator may be deposited by evaporation or vapour deposition. The layer of insulator 17 may be delimited by photolithography and etching. One end of the drain 16ᵢ of each drive transistor 11ᵢ, 11ᵢ₊₁ is released, so as to be able to be connected to a transparent electrode, as described with reference to FIG. 4C.

A first electrode 18ᵢ, which is transparent in the emission spectral band, is formed on the support 10ₛ, so as to be in contact with each drain 16ᵢ. Cf. FIG. 4C. Each first transparent electrode 18ᵢ is formed from a conductive material, for example ITO (indium tin oxide) for the visible spectral range. The thickness of each first electrode 18ᵢ may be between 10 nm and 100 nm. The first electrode 18ᵢ is pixellated: each detection pixel 10ᵢ comprises a first electrode 18ᵢ separated from the first electrode of the other detection pixels.

A layer of the photoconductive material 19ᵢ is deposited on each first electrode 18ᵢ. Cf. FIG. 4D. What is meant by “photoconductive material” is a material the electrical conductivity of which increases when it is exposed to light. The photoconductive material is intended to form charge carriers under the effect of illumination, in the emission spectral band of the light source. It may, for example, be an organic semiconductor, for example a semiconductor polymer, for example P3HT poly(3-hexylthiophene), which may be deposited by liquid means. It may also be a phthalocyanine, such as ZnPC (zinc phthalocyanine), which may be deposited by evaporation.

The thickness of the photoconductive material 19; deposited at each detection pixel 10ᵢ is adjusted so as to make possible sufficient absorption of the incident light, so as to form a usable detection signal, while making it possible to transmit the highest possible fraction of incident light. Thus, the thickness of the material is configured to make it possible to transmit at least 50%, or even 60%, or even 70%, or even 80% of the incident light. The fraction of light not transmitted is absorbed by the photoconductive material 19ᵢ so as to form the detection signal of the pixel 10ᵢ. Generally, the thickness of the photoconductive material is between 50 nm and 500 nm.

A first counter-electrode 18′ is formed on the photoconductive material 19ᵢ of each detection pixel 10ᵢ. Cf. FIG. 4E. While each first electrode 18ᵢ is pixellated, the first counter-electrode 18′ is common to all of the detection pixels. The first counter-electrode 18′ is formed from a conductive material which is transparent in the emission spectral band, for example ITO in the visible spectral band.

The steps depicted in FIGS. 4A to 4E are implemented on the support 10ₛ so as to form the detection pixels 10ᵢ. Each detection pixel may extend along a side dx which is greater than the wavelength, for example greater than 1 μm and preferably greater than a few μm, typically between 10 μm and 500 μm on a side.

A formation of a modulator 20 is now described, comprising a matrix of elementary liquid crystals, or modulation pixels, respectively coupled to the detection pixels 10ᵢ.

In the embodiment described, each modulation pixel 20ᵢ is configured to modify a polarization direction of the light, upstream of a detection pixel, in order to modulate the intensity of the signal detected by the detection pixel. What is meant by “upstream” is along the direction of propagation of the light emitted by the source. The device comprises an output polarizer 27ᵢ, downstream of each modulation pixel 20ᵢ. The output polarizer is formed from a film of metallic material 27 which is deposited against the first counter-electrode 18′. The metallic material is, for example, aluminium or silver. The thickness of the metallic film 27 is between 50 and 500 nm. Cf. FIG. 4F. The metallic film 27 is structured, so as to form, opposite each detection pixel 10ᵢ, the polarizer 27ᵢ, here taking the form of a grid, the pitch of which is typically between 50 nm and 500 nm. Cf. FIG. 4G. The grid may be sized by an electromagnetic simulation method, based on RCWA (rigorous coupled-wave analysis) or FDTD (finite-difference time-domain) algorithms. An insulating layer 27′, for example SiO₂, is then deposited on the structured metallic film 27, so as to obtain the polarizer 27ᵢ. Cf. FIG. 4H. The insulating layer 27′ is, for example, deposited by evaporation.

An opening 27ₒ is then formed through the insulating layer, opposite each drain 26ᵢ of each transistor 21ᵢ. Cf. FIG. 4I.

Second electrodes 28ᵢ are then deposited, opposite each detection pixel 10ᵢ. Cf. FIG. 4J. Like the first electrode 18ᵢ or the first counter-electrode 18′, each second electrode 28ᵢ is formed from a conductive material transparent in the emission spectral band of the light source. Each second electrode 28ᵢ fills each opening 27ₒ so as to contact the drain 26ᵢ of each transistor 21ᵢ.

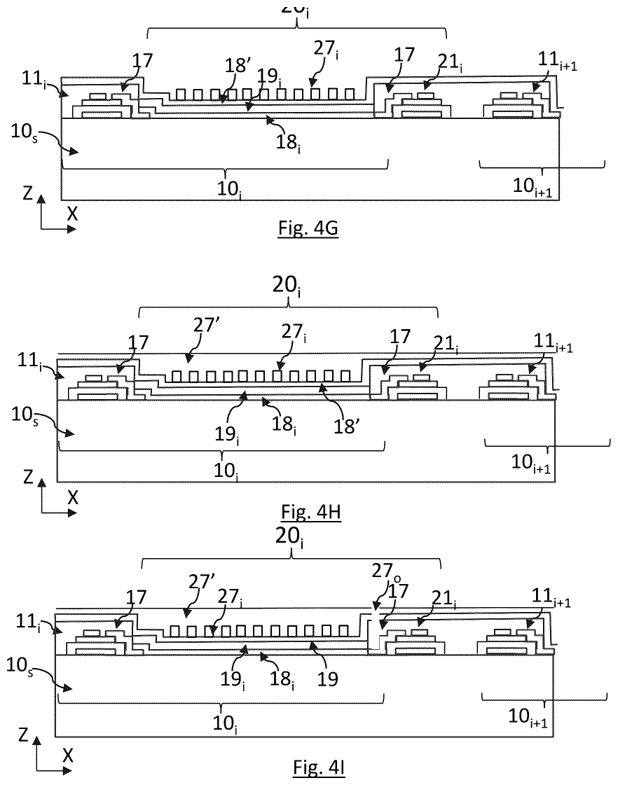

FIG. 4K shows the formation of an empty cavity 29_{c}, which is obtained by arranging a spacer SP around the stack resulting from steps 4A to 4J. FIG. 5 schematically depicts the spacer SP arranged around the assembly formed by the second electrodes 28ᵢ, in the plane XY. The spacer may be a sealtight sealing bead with a thickness of between 2 μm and 4 μm in the visible spectral range. In the infrared, the thickness may be 6 or 7 μm up to a wavelength of 8000 nm, and further beyond, for example up to 12 μm. The bead is intended to allow attachment to a cover 20ₛ. The cover 20ₛ is a transparent cover, and delimited on the one hand by a second counter-electrode 28′, and on the other hand by an input polarizer 20′. The cover 20ₛ serves as a support for the second counter-electrode 28′, and for the input polarizer 20′. The cover 20ₛ makes it possible, with the sealing bead forming the peripheral spacer SP, to delimit the cavity 29_{c}, the latter being intended to be filled with a liquid crystal material 20. The use of the input polarizer 20′ is not necessary if the source emits polarized light, or if a polarizing filter is arranged between the light source 2 and the device 1.

The spacer SP has an opening O allowing the injection of liquid crystal material 29, and a vent E for the evacuation of air when filling the cavity. The families of liquid crystals able to be used to meet the need of the invention are the families of smectics, nematics and cholesterics. The thickness of the cavity is a few μm when the light source emits in the visible spectral range, for example between 2 μm and 4 μm, as described above in relation to the thickness of the sealing bead, and more in the infrared.

FIG. 4L shows the device after the cavity 29_{c} has been filled with the liquid crystal material. The portion of liquid crystal material opposite each second electrode 28ᵢ is designated by the reference 29ᵢ.

Each modulation pixel 20ᵢ has a side length of for example between 10 μm and 500 μm. In the example shown, each modulation pixel 20ᵢ has the same size as a detection pixel 10ᵢ. Thus, each modulation pixel 20ᵢ is arranged facing a detection pixel 10ᵢ.

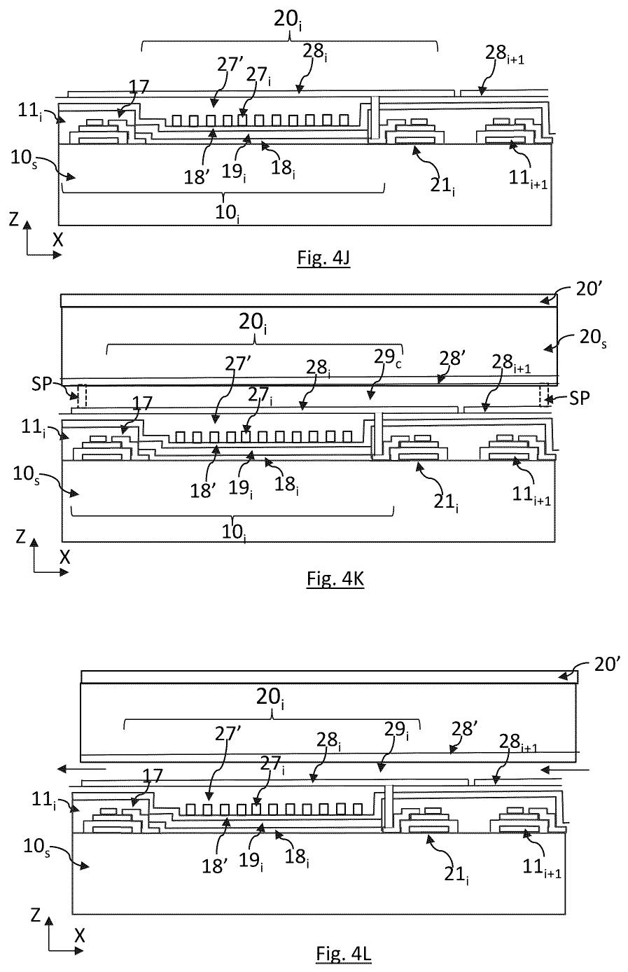

FIGS. 6A and 6B show a possible configuration of addressing electrodes, allowing an electrical connection to the drive transistors 11ᵢ and the control transistors 21ᵢ. The first counter-electrode 18′ and the second counter-electrode 28′ are brought to a fixed potential, for example a ground.

FIG. 6A shows a first polarization electrode 10_{X} forming a row and a readout electrode 10_{Y} forming a column. For each detection pixel 10ᵢ of one and the same row, parallel to the axis X, the electrode 10_{X} is connected to the gate 12ᵢ of the drive transistor 11ᵢ. The readout electrode 10_{Y} is connected to the source 14ᵢ of the drive transistor 11ᵢ, while the drain 16ᵢ of the drive transistor 11ᵢ is connected to the first electrode 18ᵢ of the detection pixel 10ᵢ. When the electrode 10_{X} is activated, the charge collected by the first electrode 18ᵢ is transferred, via the drain 14ᵢ, to the readout electrode 10_{Y}. The collected charge may be read by an amplifier, connected to the readout electrode 10_{Y}. This may be for example a capacitive transimpedance amplifier CTIA. The potential of the electrode 18ᵢ substantially reaches the potential of the readout electrode 10_{Y}, thereby resetting the detection pixel 10ᵢ. Such an arrangement allows each column electrode 10_{Y} to simultaneously read out the detection signals from the detection pixels 10ᵢ of one and the same row. The shape of each detection pixel 10ᵢ is designed so as to enable the positioning of the drive transistor 11ᵢ and the second electrode 28ᵢ.

FIG. 6B shows a polarization electrode 20_{X} forming a row and an electrode 20_{Y} forming a column. For each modulation pixel 20ᵢ of one and the same row, the electrode 20_{X} is connected to the gate 22ᵢ of the actuation transistor 21ᵢ. The electrode 20_{Y} is connected to the source 24ᵢ of the actuation transistor 21ᵢ, while the drain 26ᵢ of the actuation transistor 21ᵢ is connected to the second electrode 28i. This allows each electrode 20_{X}, via the control transistor 21ᵢ, to simultaneously activate the modulation pixels 20ᵢ of one and the same row. The shape of each modulation pixel 20ᵢ is designed so as to enable the positioning of the actuation transistor 21ᵢ and the first electrode 18ᵢ.

According to one possibility, the electrode 10_{Y} and the electrode 20_{Y} are common, and are successively used to read out the detection signal from detection pixels or to actuate modulation pixels. This results in the frame time being lengthened, since the readout of the detection signal and the actuation of the modulation pixel facing it are carried out successively.

The polarization direction of the input and output polarizers depends on the ability of the liquid crystals to polarize light. When the input and output polarizers are oriented in one and the same polarization direction, activation of the liquid crystals of a modulation pixel makes it possible to modify the polarization direction of the light, thereby reducing the light transmitted to the detection pixel positioned vertically above the modulation pixel.

When the input and output polarizers are oriented in crossed polarization directions, in the absence of activation of the liquid crystals in a modulation pixel, no light is transmitted. The activation of the liquid crystal modifies the polarization, thereby increasing the light transmitted to the detection pixel positioned vertically above the modulation pixel.

The use of an input polarizer is not necessary. Indeed, the light source may be a laser light source, or a light source coupled to a polarizing filter. The light thus arrives at the device polarized in an initial polarization direction. Preferably, the output polarizer direction is either parallel or perpendicular to the initial polarization direction.

In the example described above, each modulation pixel has the same size as a detection pixel. The arrangement of the modulation and detection pixels is such that each modulation pixel coincides with a detection pixel.

FIG. 7 depicts a variant in which two adjacent detection pixels 10ᵢ, 10ᵢ₊₁ are spaced apart from one another, so as to form an empty space, on the detection surface 10′, between said adjacent pixels, the empty space transmitting at least 50% or at least 60%, or at least 70% of the light to which it is exposed. According to this variant, the detection pixels may be opaque. It is preferable for the detection pixels 10ᵢ to occupy a reduced area of the detection surface, for example less than 10% or less than 20% or less than 30% of the detection surface. According to this embodiment, the detection pixels may be smart pixels, as described in EP33811060 or FR3125358. The size of each detection pixel 10ᵢ may then be reduced, for example between 1 μm and 10 μm, while the size of the modulation pixels 20ᵢ is for example between 10 μm and 500 μm. Thus, each detection pixel extends over an area of less than 10% or less than 20% of the area of each modulation pixel. The complementary part of the detection surface 10′ is transparent, as described above. This variant makes it possible to take advantage of the good detection sensitivity of smart pixels, this type of pixel having a low dark current (typically <1 pA/cm²), and a high detection efficiency.

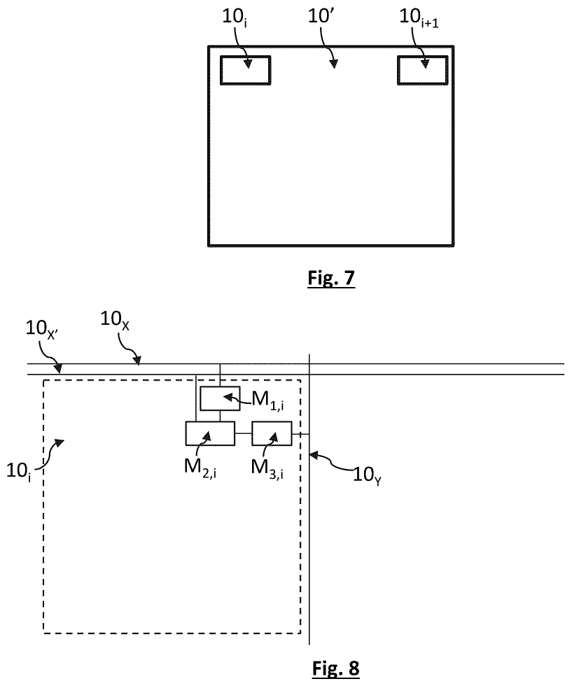

According to one variant, the detection pixels are not controlled by a TFT, but by a readout and addressing circuit using three CMOS (complementary metal-oxide semiconductor) transistors, shown in FIG. 8:
a reset transistor M_{1,i}, making it possible to connect the first electrode 18ᵢ of each detection pixel 10ᵢ to a reference potential. The reference potential is for example carried by a reference electrode 10_{X} supplying power to the pixels of one and the same row, along the X axis;
a selection transistor M_{2,i}, activated by an activation electrode 10_{X′}, activating the detection pixels of one and the same row 10ᵢ. Activating each selection transistor makes it possible to transmit the resulting detection signal from the pixel to an output transistor M_{3,i}.
the output transistor M_{3,i}, the gate of which is connected to the drain of the selection transistor M_{2,i}, and the source of which is connected to a readout column electrode 20_{Y}. The output transistor operates in follower mode.

Compared with the configuration described above, such a configuration requires the provision of two electrodes arranged along each row: the reference electrode 10_{X} carrying the reference potential and the activation electrode 10_{X}. The advantage of this configuration is lower readout noise, thereby making it possible to increase the sensitivity of the pixel.

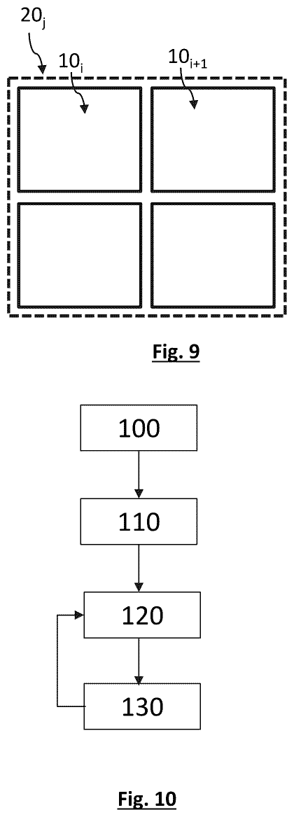

In the above example, each detection pixel 10ᵢ coincides with a modulation pixel 20ᵢ, this corresponding to an optimum configuration: the number of modulation pixels is identical to the number of detection pixels. However, the number of modulation pixels may be smaller than the number of detection pixels. A modulation pixel may thus be arranged opposite multiple detection pixels. Such a possibility is illustrated in FIG. 9. In the example shown in FIG. 9, each modulation pixel 20ⱼ addresses four adjacent detection pixels 10ᵢ. In this example, an index j is associated with each modulation pixel, with 1≤j≤J and J<I. J is an integer representing the number of modulation pixels.

In the above examples, liquid crystals make it possible to modify the polarization direction of light when they are activated. According to another possibility, each modulation pixel 20ᵢ is formed from an electrochromic material, the absorbance of which, in the emission spectral band of the light source, varies depending on an applied polarization. For example, this may be tungsten dioxide, titanium dioxide or a conductive polymer.

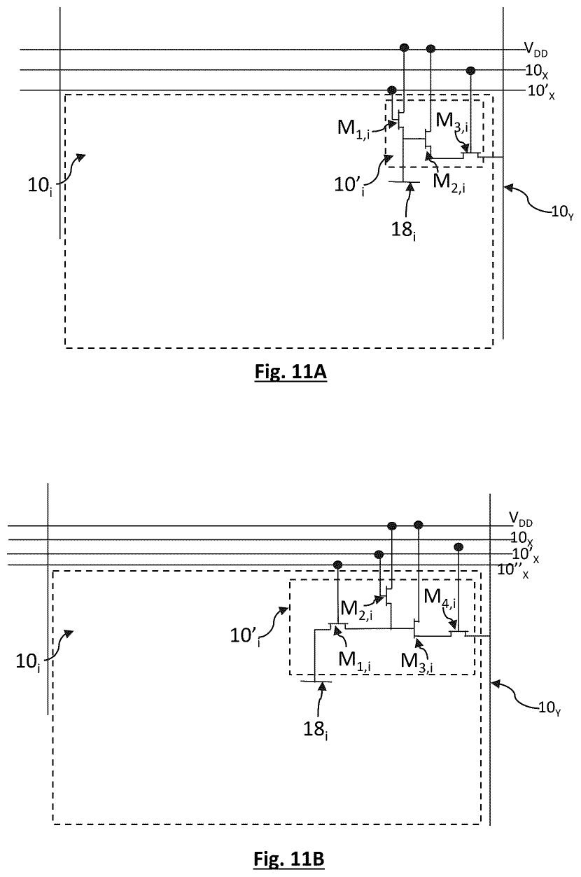

FIG. 10 schematically depicts the operations implemented by the processing unit 30 during operation of the device.

In a step 100, the control unit stores an illumination pattern to be produced. Examples of patterns have been described with reference to FIGS. 3A to 3C.

In a step 110, the light source is activated.

In a step 120, the photodetector 20 generates an illumination pattern produced by the light source, through the modulator 10.

In a step 130, the control unit compares the illumination pattern detected by the photodetector 20 with the stored illumination pattern. Based on the comparison, the modulation pixels are activated so as to modulate the intensity of the light arriving at each modulation pixel.

Steps 120 to 130 may be reiterated continuously, or until the illumination pattern is considered to be faithful to the stored pattern. This makes it possible to have an illumination device slaved to the stored illumination pattern.

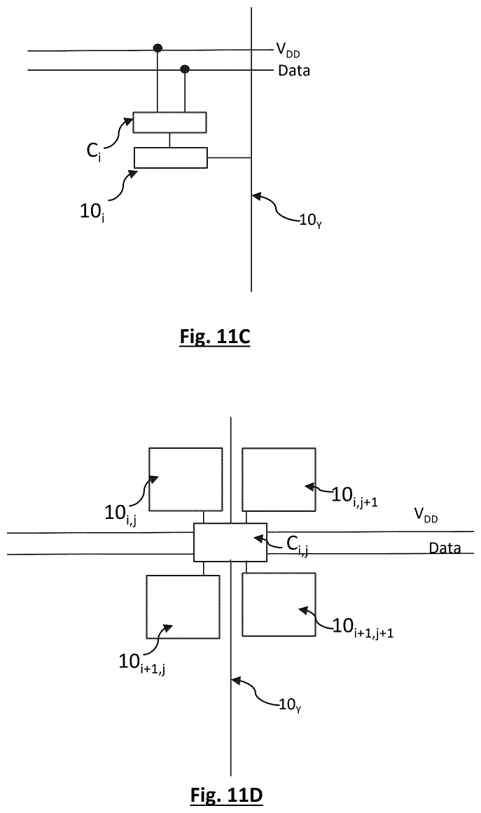

FIGS. 11A to 11D illustrate other exemplary detection pixel connections that may be implemented.

FIG. 11A corresponds to what is known as a 3T configuration, since each detection pixel 10ᵢ is controlled by three transistors M_{1,i}, M_{2,i} and M_{3,i} arranged on a connection chip 10′ᵢ. The connection chip is powered by a power supply V_{DD}, a control electrode 10_{X} and a reset electrode 10′_{X}. The transistor M_{2,i} is a transistor, operating in follower mode, that transfers the potential of the electrode 18ᵢ from the pixel 10ᵢ to the drain of the transistor M_{3,i}. Under the effect of activation by a selection electrode 10_{X}, equalization of the voltage between the drain and the source of the transistor M_{3,i} is achieved. A pulse addressed by the reset electrode makes it possible to reset the potential of the electrode 18ᵢ following a readout through the reset transistor M_{1,i}.

FIG. 11B corresponds to what is known as a 4T configuration, since each detection pixel 10ᵢ is controlled by four transistors M_{1,i}, M_{2,i}, M_{3,i} and M_{4,i} arranged on a connection chip 10′ᵢ. The connection chip 10′ᵢ is powered by a power supply V_{DD}, a control electrode 10_{X}, a reset electrode 10′_{X} and a transfer electrode 10″_{X}. The transistor M_{1,i} is a transfer transistor, transferring the charges accumulated in the electrode 18ᵢ from the pixel 10ᵢ to a floating node, which temporarily stores the charges accumulated under the effect of a pulse in the transfer electrode 10″_{X}. The transistor M_{2,i} is a reset transistor, enabling the potential of the node to be reset before the charge transfer. The transistor M_{3,i} is a follower transistor, enabling the potential of the floating node to be transferred, possibly with amplification, to the readout transistor M_{4,i}, the latter being controlled by the control electrode 10_{X} so as to discharge to the readout electrode 10_{Y}. The 4T configuration makes it possible to read out the signal from each pixel with reduced readout noise. However, it is bulkier than the 3T structure shown in FIG. 11A and assumes an additional control line, in this case the transfer electrode 10″_{X}.

The architectures depicted in FIGS. 11A and 11B may work on a transparent detection pixel with a large area or on an opaque detection pixel with a small area. When implementing detection pixels with a large area, the need for a certain degree of transparency to incident photons reduces sensitivity per unit area. The reduced surface sensitivity is compensated for by an extended detection area. One alternative is to have an opaque, more sensitive detection pixel with a small area. The sensitivity is then concentrated on a small area.

FIG. 11C describes a configuration in which each detection pixel 10ᵢ is controlled by a controller Cᵢ, the latter being powered by a power supply line V_{DD} and a data line Data, which carries a control signal. The controller makes it possible to drive a connection chip 10ᵢ′ of each pixel 10ᵢ, by being driven by the control signal. The connection chip 10′ᵢ may be as described in connection with FIGS. 11A and 11B. The controller thus makes it possible to manage each transistor of the connection chip 10′ᵢ. The controller is configured to demodulate the control signal, so as to drive the readout and resetting of the pixel to which it is connected.

FIG. 11D illustrates pooling of a controller C_{i,j}, the latter being powered by a power supply line V_{DD} and a data line Data. The controller C_{i,j} makes it possible to drive connection chips 10′_{i,j}, 10′_{i,j+1}, 10′_{i+1,j}, 10′_{i+1,j+1} respectively associated with four pixels 10_{i,j}, 10_{i,j+1}, 10_{i+1,j}, 10_{i+1,j+1}, by being driven by the control signal. The connection chips may be as described in connection with FIGS. 11A and 11B. Like in the configuration depicted in FIG. 11C, the controller makes it possible to manage each transistor of the connection chips 10′_{i,j}, 10′_{i,j+1}, 10′_{i+1,j}, 10′_{i+1,j+1}. The controller is configured to demodulate the control signal, so as to drive the readout and resetting of each pixel 10_{i,j}, 10_{i,j+1}, 10_{i+1,j}, 10_{i+1,j+1} to which it is connected.

1. A device for illuminating an object, the device being configured to be lit by a light source, the light source emitting light in an emission spectral band, the device comprising:
a pixellated photodetector, comprising detection pixels distributed along a detection surface;
a modulator, formed from a matrix of modulation pixels, interposed between the light source and the pixellated photodetector, each modulation pixel comprising a material an optical property of which varies depending on an electrical command applied to said modulation pixel;
a control unit, configured to activate each modulation pixel depending on a light intensity detected by the detection pixels, so as to modify a light transmission of at least one modulation pixel;
wherein:
the detection surface transmits part of the light in the emission spectral band, so that the light transmitted by the pixellated photodetector illuminates the object;
so that the device is configured to be placed between the light source and the object.

2. The device according to claim 1, wherein each detection pixel transmits at least 50%, or at least 60%, or at least 70% of the light in the emission spectral band.

3. The device according to claim 1, wherein two adjacent detection pixels are spaced apart from one another, so as to form an empty space, on the detection surface, between said adjacent pixels, the empty space transmitting at least 50% or at least 60%, or at least 70% of the light in the emission spectral band.

4. The device according to claim 1, wherein each modulation pixel is configured to modify a polarization direction of light depending on the electrical command applied to said modulation pixel, the device comprising an output polarizer interposed between the modulator and the pixellated photodetector.

5. The device according to claim 4, comprising an input polarizer, wherein the modulator s interposed between the input polarizer and the output polarizer.

6. The device according to claim 1, wherein each modulation pixel is configured to modify an absorbance of the light emitted by the light source depending on the electrical command applied to said modulation pixel.

7. The device according to claim 1, wherein the control unit is configured to:
a) store an illumination pattern;
b) receive a detection signal representing a light intensity detected by the pixels of the photodetector;
c) activate each modulation pixel depending on the light intensity detected by the pixels of the photodetector and the stored illumination pattern.

8. The device according to claim 1, wherein the pixellated photodetector and the modulator are attached to one another.

9. The device according to claim 1, wherein the pixellated photodetector and the modulator are arranged in contact with one another or at a distance of less than 1 cm from one another.
